(19) United States
(12) Patent Application Publication
(10) Pub. No.: US 2012/0046788 A1
(43) Pub. Date: Feb. 23, 2012

(54) SPEECH SYSTEM USED FOR ROBOT AND ROBOT WITH SPEECH SYSTEM

(75) Inventor: Dongqi Qian, Jiangsu (CN)

(73) Assignee: TEK ELECTRICAL (SUZHOU) CO., LTD., SUZHOU CITY, JIANGSU (CN)

(21) Appl. No.: 13/145,683

(22) PCT Filed: Jan. 22, 2010
(86) PCT No.: PCT/CN2010/070316

§ 371 Date: Oct. 3, 2011

(30) Foreign Application Priority Data
Jan. 24, 2009 (CN) 2009100040031

(51) Int. Cl. B25J 19/02; G10L 13/04

(52) U.S. Cl. 700/257; 704/258; 901/1; 901/46; 704/E13.005

(57) ABSTRACT

A speech system (2) used for a robot (1) and a robot (1) with the speech system (2) are provided. The speech system (2) includes an audio file storage unit (200) and a speech control unit (300). The audio file storage unit (200) stores audio files obtained from an audio file preparation unit (100), which is located outside the robot (1). The data stored in the audio file storage unit (200) can be prepared, modified or replaced according to the requirement of a user. According to the received robot state information, the speech control unit (300) converts the audio data of the audio file, which corresponds to the state information and is stored in the audio file storage unit (200), to a corresponding analog signal, and then plays the analog signal.

### FIELD OF THE INVENTION

The present invention relates to a robot system, in particular, to a speech system used for a robot and a robot with the speech system.

### DESCRIPTION OF THE PRIOR ART

In the process of operating and/or using of a traditional robot currently available in the market (for example, an self-driven cleaning robot), if the robot is in situations such as, insufficient power supply, being tangled in wires and unable to move or the charging is completed, the user is generally warned through the alarming sound sent by a buzzer or a similar acoustic device configured inside the robot or through a displayed codes of specific meaning, such as “ERR01” or “ ” etc, on a display such as a built-in man-machine interface in the robot. In the case that a user is warned through an alarming tone, the alarming tones are usually all the same and the user cannot know timely and directly what is the real problem with the robot. In case a user is warned by displayed codes, the user usually needs to refer to the operation manual to understand the meaning of the displayed code and to know about the real problem with the robot, which means the user still cannot get to know about the real problem with the robot. All these cases bring quite some inconvenience for the user.

In recent years, a self-driven robot named roomba produced by American IROBOT Corporation is provided with a built-in speaker. Upon occurrence of any fault, roomba will firstly send sound “Uh oh” and then send beeping sound. By counting the times of the “beeping sound” and referring to the “troubleshooting” column in the operation instruction manual of product, the user is able to know about the actual circumstances of robot. Compared with the previous solution, this solution still fails to provide the user with sufficient convenience in use, although the user can tell out the actual problem with the robot through the alarming sound and counting the beeping times.

An improved technical solution is disclosed in patent document CN1876337A (publication number) of LG Electronics Co., Ltd. According to CN1876337A, a user can use recorded speech as the state alarming information of the robot. The speech recording process is as follows: 1. A user presses a special button set on the cleaning robot to request speech recording; 2. Upon confirmation of the need for speech input, the controller switches the operation mode of cleaning robot to speech recording mode; 3. The user presses the special button to start recording; 4. The speech coder encodes the user's speech that is input through microphone, and the encoded sound signals are stored in the specific address designated by the controller in the memory; 5. Upon user's request to stop the recording mode, the controller stops the recording mode and switches the operation mode of cleaning robot according to the command input subsequently by the user.

Based on the above mentioned solution offered by LG Corporation, when the robot working is under a certain operation state, the operation state information of self-driven robot is informed to the robot through the speech recorded by the user. The information content is very straightforward assuring beneficial interaction between the product and the user.

However, according to this solution, a reminder speech input unit (such as a microphone and a speech coder) must be configured inside the robot additionally, and the recorded sound is merely limited to the user's sound, so that the sound information content is rather monotonous. Meanwhile, the whole process of the speech recording is fairly cumbersome; the user has to make many times of judgment and key pressing for conformation on the man-machine interface of the self-driven robot. In addition, to ensure that the recorded sound is clear and loud enough to have good recording effect, the user has to get very close to the microphone, and the user even has to hold the robot up or place the robot at a particularly picked position when recording, which are quite burdensome for the user. What is more, the speech can only be recorded for informing changes of the robot operation state. The speech function does not work when the robot is in standby state, or is being charged or in other normal operation state. So the speech function of this product is very limited. Additionally, many components such as speech coder and microphone have to be configured to achieve the function of built-in speech input unit of the robot itself, so that cost of the product is increased unintentionally.

### SUMMARY OF THE INVENTION

To overcome the deficiency of the prior art, the present invention provides a speech system used for robot and a robot with the speech system. The speech system of present invention is capable of providing different speech contents according to different operation states of the robot. Furthermore, the speech contents can be obtained from extensive sound sources rather than being limited to the robot equipment itself, and a user can prepare, modify or replace the speech contents according to own preference while using the robot, so that the robot application is more user friendly and enjoyable.

To address the aforementioned technical problems, the speech system for robot provided in the present invention including an audio file storage unit and a speech control unit, wherein the audio file storage unit stores the audio files obtained from an audio file preparation unit, the audio file preparation unit is configured outside of the robot; the data stored in the audio file storage unit can be prepared, modified or replaced according to the needs of a user; the speech control unit is coupled to the audio file storage unit to realize information transmission and data reading; according to the received robot state information, the speech control unit converts the audio data of the audio file, which corresponds to the state information and is stored in the audio file storage unit, to a corresponding analog signal, and then plays the analog signal.

In said speech system, the audio file storage unit is an independent external storage unit to the robot, and it is communicated with the robot in wired or wireless mode, and may obtain the audio file from the audio file preparation unit or from a third party in which the audio file prepared by the audio file preparation unit is stored.

In the speech system used for robot, the speech control unit includes a control subunit, an audio signal processor and a speaker, wherein the control subunit is respectively connected with the audio signal processor and the audio file storage unit; wherein, according to the received robot state information, the control subunit reads the audio file from the audio file storage unit corresponding to the state information, and sends the audio file to the audio signal processor; the audio signal processor is used to make signal processing for the audio file, and outputs the processed analog signal which corresponds to the state information to the speaker to be played.

In the speech system used for robot, the speech control unit can also be carried out according to another solution as follows: the speech control unit includes a control subunit (301′), an audio signal processor and a speaker; the audio signal processor is respectively connected with the control subunit and the audio file storage unit; wherein, according to the received robot state information, the control subunit sends an information to the audio signal processor requesting the audio signal processor to output the audio data corresponding to the state information; after receiving the information, the audio signal processor reads the audio file from the audio file storage unit corresponding to the state information, makes signal processing for the audio file, and finally outputs the processed analog signal which corresponds to the state information, to the speaker to be played.

Preferably, the audio signal processor, the speaker and the audio file storage unit are integrated to constitute an external removable storage and playing device, which is independent of the robot.

The control subunit is connected with coupled with the removable storage and playing device wirelessly.

In the speech system used for robot, the audio file storage unit may include a wireless communication circuit, and the control subunit is coupled to the audio file storage unit in wired or wireless connection.

Specifically, the wireless communication means is infrared or Bluetooth mode; the wired connection means that the control subunit or the audio processor is coupled with the audio file storage unit through USB interface, IEEE1394 interface, RS232 interface, SPI interface, IIC interface or RS485 interface.

The audio file storage unit is a SD card, a XD card, a CF card, a XF, a MMC card or a U disk.

According to another aspect of the present invention, the audio file storage unit can also be a memory configured inside the robot. Through a communication interface, the memory downloads or records the audio file from the audio file preparation unit or from a third party in which the audio file prepared by the audio file preparation unit is stored.

In the speech system used for robot of which the audio file storage unit is a memory configured inside the robot; through a communication interface, the audio file storage unit downloads or records the audio file from the audio file preparation unit or from a third party in which the audio file prepared by the audio file preparation unit is stored.

In the speech system used for robot of which the audio file storage unit is a memory configured inside the robot, the speech control unit includes a control subunit, an audio signal processor and a speaker; the control subunit is respectively connected with the audio signal processor and the audio file storage unit; wherein, according to the received robot state information, the control subunit reads the audio file from the audio file storage unit corresponding to the state information, and sends the audio file to the audio signal processor; the audio signal processor processes the audio file signals and outputs the processed analog signal, which corresponds to the state information, to the speaker to be played.

In the speech system used for robot, wherein the audio file storage unit is a memory configured inside the robot, the speech control unit includes a control subunit, an audio signal processor and a speaker; the audio signal processor is respectively connected with the control subunit and the audio file storage unit; wherein, according to the received robot state information, the control subunit sends information to the audio signal processor requesting the audio signal processor to output the audio data corresponding to the received robot state information; after receiving the information, the audio signal processor reads the audio file from the audio file storage unit corresponding to the state information, makes signal processing for the audio file processes the audio file signals, and finally outputs the processed analog signal, which corresponds to the state information, to the speaker to be played.

In each of said speech systems used for robot, the third party refers to Internet or a file storage device, and the device may be a computer, a mobile phone or a personal digital assistant. In each of said speech systems used for robot, a plurality of audio file corresponding to one state of robot is stored in the audio file storage unit.

In each of said speech systems used for robot, the audio file is in the format of MP3, WAV, WMA, MP2, OGG, APE, AAC, MIDI or VQF. In each of said speech systems used for robot, a built-in memory is configured inside the robot to store the standard audio file corresponding to the robot state. According to the received robot state information and application conditions, the speech control unit converts the audio file data that corresponds to the state information and is stored in the audio file storage unit or the built-in memory to a corresponding analog signal to be played.

Specifically, the application condition refers to user instruction or application priorities.

To address the technical problem targeted in this invention, the present invention also provides a robot with speech function, including a control system, a sensor system, a driver system, an implement mechanism and a man-machine interface. Wherein, the man-machine interface is used for man machine interaction the control system is used to control the driver system so as to drive the implement mechanism to perform the corresponding tasks. The sensor system is used to detect the operation state of the robot. The robot also includes the above recited speech system, the speech system plays the audio file corresponding to the state information detected by the sensor system. The speech control unit in the speech system is a component unit of the control system.

The robot may be a dusting robot. Accordingly, the sensor system includes a sensor for detecting the working environment, a sensor for detecting the operation state and a signal processing circuit corresponding to the sensors; the implement mechanism is a cleaning unit; the driver system includes a working motor used to drive the cleaning unit to work, the wheels for the mobility of the robot and its driving motor. The control system is used to control the robot to complete the dusting work, and it interacts with the speech system to play different audio files under different operation states; the man-machine interface is the operation interface of the robot. The sensors used to detect the operation state include infrared sensor and/or piezoelectric sensor.

Compared with the prior art, the present invention has the following advantageous effects:

1. The audio file storage unit involved in the present invention can be embodied as different kinds of memory cards in the prior art, and the audio file can be directly downloaded to the audio file storage unit from the audio file preparation unit external to the robot or downloaded through a third party. The audio file preparation unit may be many common household devices or tools such as mobile phone and computer. Since different kinds of sounds can be recorded or downloaded through these common devices, the sources of sounds are very extensive and diversified.

2. Since reminder speech of the self-driven robot is recorded or downloaded through common household devices and tools, such as mobile phone and computer, which are connected to the robot, the user only needs to get close to the microphone of the mobile phone or the computer or use many other convenient means that may be connected with the microphone interface of mobile phone or computer, for example, wearing earplug with microphone, so as to easily carry out the recording without “demanding labors”. In addition, the speech system of this invention is provided with speech downloading functionality, so that a user can search, modify or change file from an all-inclusive “sound information library” through convenient and simple operations, such as press the keys to select on mobile phone or operate the computer mouse.

3. The speech recorded or downloaded by the user can act not only as the speech reminder for informing the user of the operation state of the self-driven robot, the speech also offer recreational functionalities; when the self-driven robot is under other good operation state, for example, standby state or is being charged, corresponding audio files stored in the audio file storage unit, can be played to have pleasurable effect or to be helpful for personal study. Thus, the speech function becomes even powerful with diversified contents.

4. The present system also utilizes the devices with recording function, such as speech coder and microphone which are carried in the common household devices and tools. The automated device is connected with the common household devices/tools to realize the recording or download of data from the original household devices, and the data recorded or downloaded in such manner is the suitable format for storage. By merely connecting the automated device with the interface set on the self-driven robot, a user can realize the function of playing speech. The present system takes full advantage of the original household device resources and reduces the cost of automated system itself.

5. The input of speech is realized in the mode of recording or downloading audio file. Such mode sufficiently embodies the friendly interaction between the product itself and the user, and improves the affinity of product. As a result, the product manufactured according to the present invention can not only act as a tool for operation and use, but also reflect the personal traits of the user, thus adding interests in family life.

### BRIEF DESCRIPTION OF THE DRAWINGS

FIG. 1 is a block diagram showing the operational principle of the robot with speech system of the present invention;

FIG. 2 is a flow chart showing how the robot with the speech system of the present invention plays different audio file corresponding to its state information;

FIG. 3 is a block diagram showing the structural and operational scheme of the robot with the speech system according to embodiment 1 of the present invention;

FIG. 4 is the structural diagram of the robot with speech system according to embodiment 1 of the present invention;

FIG. 5 is a block diagram showing the structural and operational scheme of the robot with the speech system according to embodiment 2 of the present invention;

FIG. 6 is a block diagram showing the structural and the operational scheme of the robot with the speech system according to embodiment 3 of the present invention;

FIG. 7 is a block diagram showing the structural and the operational scheme of the robot with the speech system according to embodiment 4 of the present invention;

FIG. 8 is a block diagram showing the structural and the operational scheme of the robot with the speech system according to embodiment 5 of the present invention;

FIG. 9 is a block diagram showing the structural and the operational scheme of the robot with the speech system according to embodiment 6 of the present invention;

FIG. 10 is a block diagram showing the structural and the operational scheme of the robot with the speech system according to embodiment 7 of the present invention.

### DETAILED DESCRIPTION OF THE PREFERRED EMBODIMENTS

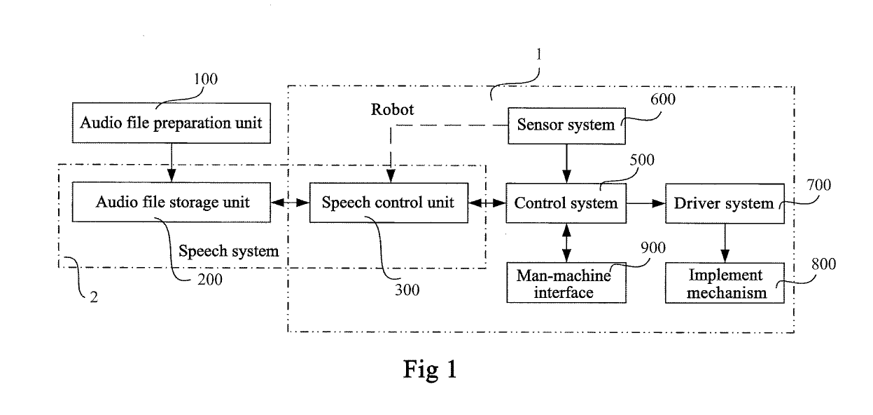

FIG. 1 is a block diagram showing the structural and operational principle of the robot with speech system of the present invention. As shown in FIG. 1, the robot 1 of the present invention is equipped with a speech system 2, the robot 1 includes a control system 500, a sensor system 600, a driver system 700, an implement mechanism 800 and a man-machine interface 900; wherein the man-machine interface 900 is used for man machine interaction, the control system 500 is used to control the driver system 700 so as to drive the implement mechanism 800 to perform the corresponding tasks; the sensor system 600 is used to detect the operation state of the robot.

The speech system includes an audio file storage unit 200 and a speech control unit 300; the audio file storage unit 200 stores the audio file obtained from an audio file preparation unit 100. The audio file preparation unit 100 is a separated device located outside of the robot 1 independently. The speech control unit 300 is coupled to the audio file storage unit 200 in wired or wireless connection to make information transmission and data reading or exchange. The speech control unit 300 receives the operation state information of robot, which is detected by the sensor system 600, the state information can be directly sent by the sensor system 600 to the speech control unit 300, or firstly received by the control system 500 from the sensor system 600, and then sent by the control system 500 to the speech control unit 300 after being transacted. According to the received robot state information, the speech control unit 300 converts the audio data of the audio file, which correspond to the state information and is stored in the audio file storage unit 200, to a corresponding analog signal to be played.

In the present invention, the robot 1 can be a robot with various functions, such as a cleaning robot. The audio file storage unit 200 stores the audio file for informing of the operation state of robot 1. For example, in the cases of a cleaning robot, the operation state can be the state of operation start, the immobility state, the state of task completion or the state of jammed clearing brush. For each different state, one or more audio files corresponding to such states are stored in the audio file storage unit 200. Besides being able to storing the audio data for informing of the changes in operation state, the audio file storage unit 200 is also capable of registering audio information for normal operation states, for example, when the cleaning robot is in standby state, or is under the state of being charged or in other good operation state. For such stable and good operation states of the cleaning robot, the audio file storage unit 200 may be stored with some pleasurable music or other recreational audio works including comic dialogue or drama, or even foreign language study materials, such as, news or short articles.

Since the audio file stored in the audio file storage unit 200 is obtained from an independent audio file preparation unit 100 external to the robot, the audio file stored in the audio file storage unit 200 can be prepared, replaced or modified by a user according to his/her own requirements and preference. Therefore, whether it is in case of storing changes-warning audio files or of storing good operation state-informing audio files, the audio file storage unit 200 can be coupled to the audio file preparation unit 100, such as, mobile phone, PC and other household devices, and the audio files can be downloaded or recorded using the encoder, microphone and other corresponding configurations of these common household devices, and the audio data can be modified therewith according to actual needs. Depending on the user's preference, such audio data can be of speech or musical tune. For an example, corresponding to a cleaning-completed state, such audio content, “work completed, need rest”, may be downloaded or recorded and be stored in the audio file unit 200.

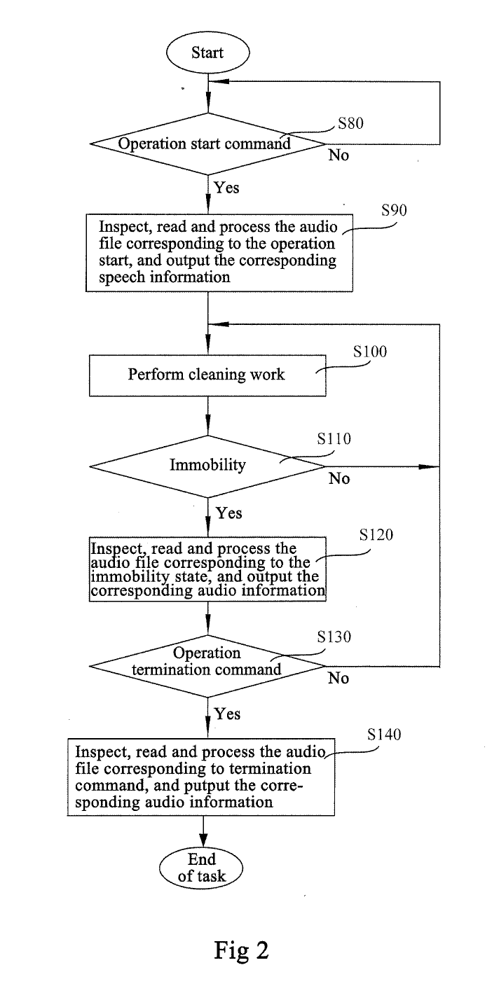

FIG. 2 shows the flow chart of a specific embodiment in which different audio files are played according to the robot state information. The speech control unit 300 judges whether there is operation start information (S80). If the command to start operation is input by a user, the speech control unit 300 receives this information, inspects the audio data stored in the audio file storage unit 200, reads the audio file stored in the corresponding “operation start” file, and after processing, outputs audio information—“cleaning robot starts work” (S90) through the speaker, and the cleaning robot implement the cleaning operation (S100) subsequently. In the process of cleaning operation, the sensor system 600 inspects the operation state of the cleaning robot to judge whether it moves normally (S110). For example, when the cleaning robot meets an obstacle and cannot move, the sensor system 600 sends such information to the speech control unit 300; the speech control unit 300 then inspects the audio information stored in the removable memory, reads the audio file corresponding to the detected state, and outputs such speech as “meet an obstacle, cannot move” (S120) through the speaker. Through such speech that is independently recorded or downloaded by the user, the state of cleaning robot can be informed to the user promptly, so that the user can make quick response and take necessary measures. The speech control unit 300 is capable of repeating inspecting the state of the cleaning robot, reading the corresponding audio information (S130) and outputting such information through the speaker until the user inputs the command to stop the operation of the cleaning robot and outputs the corresponding audio information (S140).

In addition to the case shown in FIG. 2, where it is necessary to inform of the operation state of the robot, when the self-driven robot is in charging state or standby state or similar case where it is unnecessary to inform of the operation state of the robot, the speech control unit 300 can read and output from the audio file storage unit 200 the audio file corresponding to the situation of “Unnecessary to inform of the changes in operation state”. The audio data in this audio file can be pleasurable music or English study materials. Related contents to this regard have been previously described; no more unnecessary details will be repeated herein.

In addition, based on the well-functioning man-machine interface of the robot 1, a user can operate on the audio file in the audio file storage unit 200. For example, a user can convert the audio file for a particular state to the audio file for another state or delete the audio file that is disliked.

A plurality of audio files corresponding to a particular state of robot can be stored in the audio file storage unit 200. The audio files can be in different formats such as MP3, WAV, WMA, MP2, OGG, APE, AAC, MIDI or VQF.

With reference to operational principles in the block diagram and flow chart, the technical solutions for realizing the speech function of the robot in the present invention are described in detail as follows:

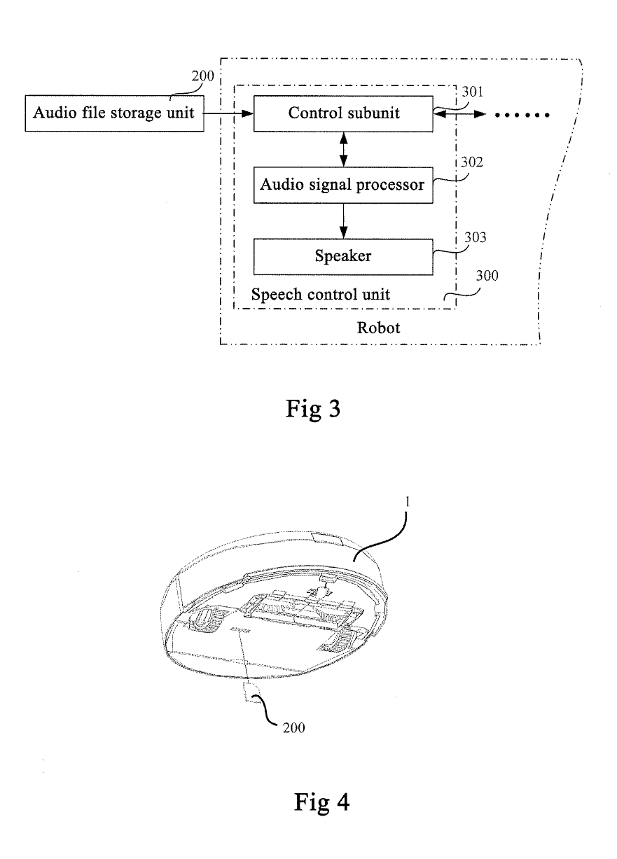

FIG. 3 is a block diagram showing the structural and operational scheme of the robot with the speech system according to embodiment 1 of the present invention.

In this embodiment, the speech system includes a control subunit 301, an audio signal processor 302 and a speaker 303. The control subunit 301 is respectively connected with the audio signal processor 302 and the audio file storage unit 200; wherein according to the received robot state information, the speech control unit 301 reads from the audio file storage unit 200 the audio file corresponding to the state information, and sends the audio file to the audio signal processor 302; the audio signal processor 302 is used to make signal processing for the audio file and outputs the processed analog signal, which corresponds to the state information, to the speaker 303 to be played. With regard to the component systems included in the robot, as they are the same as shown in FIG. 1, these component systems will no longer be described in details here with reference to FIG. 3 and nor subsequently with reference to other figures.

In this embodiment, the speech control unit 300 is located inside the robot, while the audio file storage unit 200 is located outside the robot. In such case, the control subunit 301 can be coupled to the audio file storage unit 200 in wired or wireless connections so that the control subunit 301 can read audio file from the audio file storage unit 200.

When the audio file storage unit 200 is embodied as memory cards, such as SD card, XD card, CF card, XF, MMC card or U disk, different data interfaces, such as USB interface, IEEE1394 interface, RS232 interface, SPI interface, IIC interface or RS485 interface, can be configured accordingly on the corresponding position of the robot, so that the control subunit 301 can make data transmission with the audio file storage unit 200 through said interface. The structure of the specific embodiment is shown in FIG. 4.

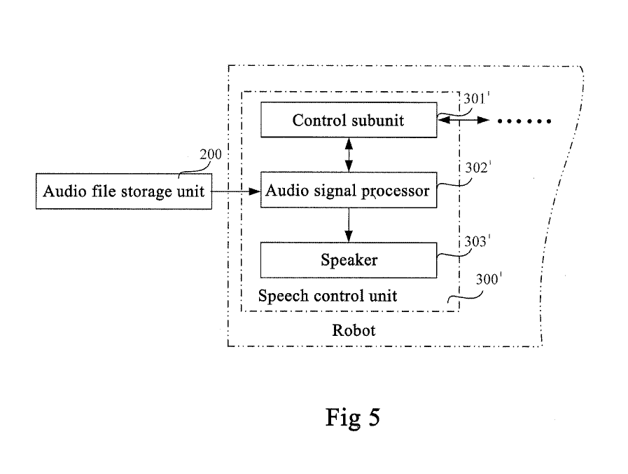

In this embodiment, the control subunit 301 is used to read the audio file in the audio file storage unit 200. On the other hand, the audio signal processor 302 can also be used to read the audio file in the audio file storage unit 200. FIG. 5 is a block diagram showing the structural and operational scheme of the robot with the speech system in embodiment 2. As shown in FIG. 5, according to the received robot state information, the control subunit 301′ sends information to the audio signal processor 302′ requesting the audio signal processor to output the audio data corresponding to the state information. After receiving the information, the audio signal processor 302′ reads the audio file from the audio file unit 200 corresponding to the state information, makes signal processing for the audio file, and finally outputs the processed analog signal which corresponds to the state information to the speaker 303′ to be played.

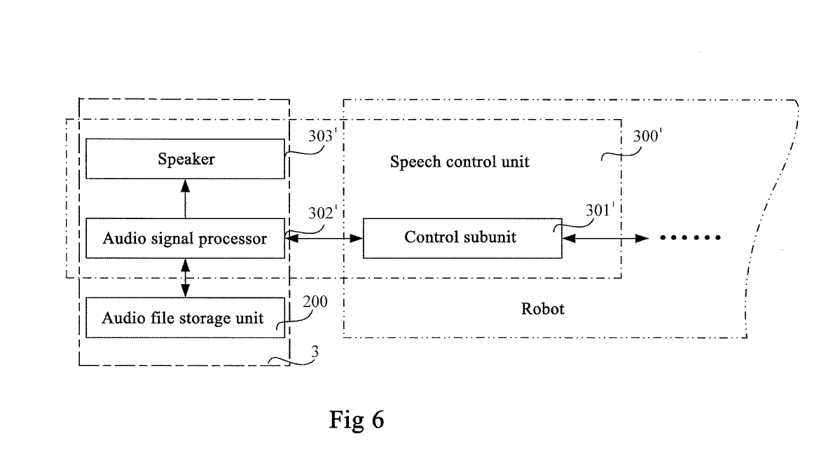

The audio signal processor 302′, the speaker 303′ and the audio file storage unit 200 as shown in FIG. 5 can be integrated to constitute an external removable storage and player device, which is independent of the robot. FIG. 6 is the block diagram showing the structural and operational scheme of the robot with the speech system in embodiment 3 of the present invention. As shown in FIG. 6, the audio signal processor 302′, the speaker 303′ and the audio file storage unit 200 constitute collectively an external removable storage and player device 3, which is independent of the robot, and which can be specifically made into a player similar to MP3 or MP4 product. Through its data interface, the robot is coupled to this player device 3. The control subunit 301′ sends the command for playing the audio file corresponding to a state to the player device 3. After the player device 3 receiving the command, the audio signal processor 302′ configured inside the player device 3 reads the audio file in the audio file storage unit 200, and outputs the audio signal through the speaker 303′ configured on it.

Since the audio file storage units 200 shown in FIG. 3, FIG. 5 and FIG. 6 are removable storage devices set outside the robot, in addition to making wire transmission through said various interfaces, the file storage unit 200 can also make data transmission with the robot in wireless connection mode. If wireless data transmission is employed, it is necessary to establish wireless communication circuit in the audio file storage unit 200. Obviously, it is also necessary to provide the corresponding wireless communication circuit on the speech control unit or the robot so as to constitute a complete wireless transmission channel. Various wireless transmission means can be employed, and the simplest means include infrared and Bluetooth devices. In particular, when the player device 3 is adopted, wireless transmission mode can generate preferable effect for the data transmission between the player device 3 and the control subunit 301 in the robot.

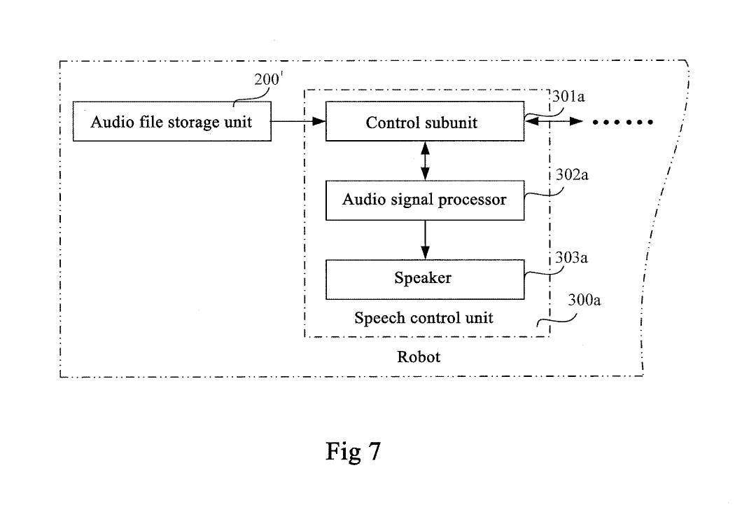

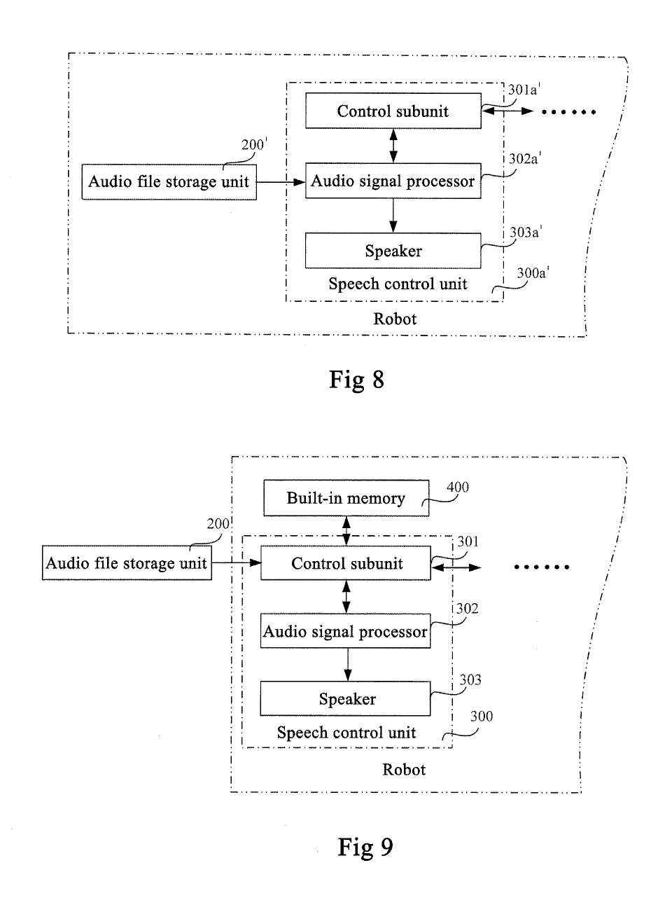

On the other hand, the audio file storage unit can also be configured inside the robot, and it can download or record audio file from the devices outside the robot, such as computer or mobile phone, through a communication interface. The schematic structure the audio file storage unit is shown in FIG. 7 and FIG. 8.

FIG. 7 is the block diagram showing the structural and operational scheme of the robot with the speech system according to embodiment 4 of the present invention. As shown in FIG. 7, the speech control unit 300a includes a control subunit 301a, an audio signal processor 302a and a speaker 303a; the control subunit 301 is respectively connected with the audio signal processor 302a and the audio file storage unit 200; wherein according to the received robot state information, the speech control unit 301 reads the audio file from the audio file storage unit 200′ corresponding to the state information and sends the audio file to the audio signal processor 302a; the audio signal processor 302a is used to make signal processing for the audio file and outputs the processed analog signal, which corresponds to the state information, to the speaker 303a to be played.

FIG. 8 is the block diagram showing the structural and operational scheme of the robot with the speech system according to embodiment 5 of the present invention. As shown in FIG. 8, the speech control unit 300a′ includes a control subunit 301a′, an audio signal processor 302a and a speaker 303a ′; the audio signal processor 302a′ is respectively connected with the audio signal processor 302a′ and the audio file storage unit 200′; wherein according to the received robot state information, the speech control unit 301a′ sends an information to the audio signal processor 302a′ requesting the audio signal processor to output the audio data corresponding to the state information. After receiving the information, the audio signal processor 302a reads the audio file from the audio file storage unit 200′ corresponding the state information, makes signal processing for the audio file, and finally outputs the processed analog signal which corresponds to the state information to the speaker 303a's to be played.

When it is necessary to modify the audio file in the audio file storage unit 200′ as shown in FIG. 7 and FIG. 8, the audio file storage unit 200′ can be connected with the external devices, such as computer and mobile phone etc., through a data interface and a data line, and the audio file can be downloaded to the audio file storage unit 200′ configured inside the robot from the external device. The audio file can also be directly recorded to the audio file storage unit 200′ from external audio file preparation units, such as a computer, mobile phone PDA, via data lines. The audio file storage unit 200 can be embodied as various kinds of erasable memory.

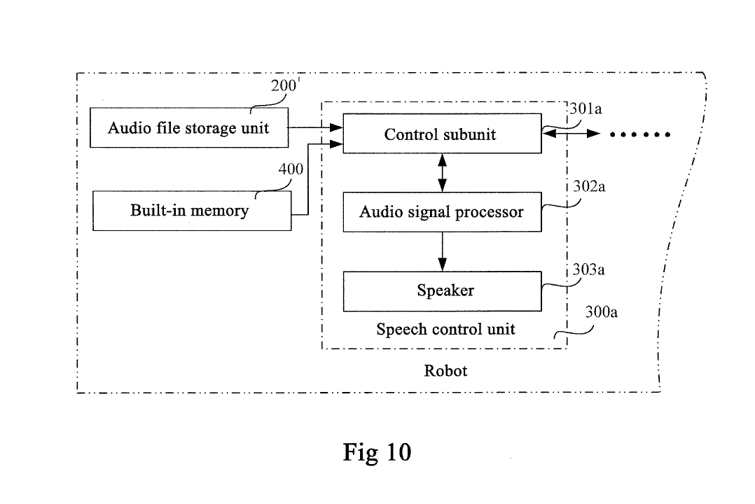

In the structure of each of the above embodiments, it is also feasible to set a built-in memory 400 inside the robot. As shown in FIG. 9 which corresponds to embodiment 6 and in FIG. 10 which corresponds to embodiment 7, the memory 400 stores a standard audio file corresponding to the robot states; the standard audio file is written by the manufacturer of the robot. According to the received robot state information and the application conditions, the audio control unit 300, 300′, 300a or 300a′ converts the audio data in the audio file, which corresponds to the state information and is stored in the audio file storage unit 200 or 200′ or the built-in memory 400, to a corresponding analog signal to be played. The application condition described here can be determined according to actual circumstances; they can be the command input by a user through man-machine interface or the application priority set by a user or manufacturer. For instance, if an external audio file storage unit is connected, audio file employment priority is given to the audio file in external audio file storage unit. If no external audio file storage unit is provided, audio file employment priority is given to the audio file in the built-in memory 400. Or, the user may select which storage unit to be used.

Referring to FIG. 1 again, the robot 1 of the present invention can be embodied as an automatic sweeper or an automatic mopping robot or a dusting robot. According to different function of the robot, it is necessary to make corresponding changes to the components configured at different positions of the robot as shown in FIG. 1. For example, when the robot 1 is a dusting robot, the sensor system 600 includes a sensor used to detect the working environment, a sensor used to detect the operation state and a signal processing circuit corresponding to the sensors. The implement mechanism 800 is a cleaning unit. The driver system 700 includes a working motor used to drive the cleaning unit to work as well as the wheels for mobility of the robot and their driving motors. The control system 500 is used to control the robot to complete the dusting work, and interact with the speech system so that different audio files may be played under different operation states. The man-machine interface 900 is the operation interface of the robot. More specifically, the sensor used to detect the operation state includes an infrared sensor and/or piezoelectric sensor.

The above recited structure of the dusting robot may be the same as in prior art. Prior patent documents with publication numbers KR20040087185, WO07065033A2, WO0038026A1 and WO0036969A1 all have disclosure of this structure, so detailed description of such structure will not be repeated in this application.

The audio file stored in the storage unit in the prevent invention can be modified, deleted or replaced by a user. In addition, the storage unit can be embodied as different kinds of removable memory cards. This solution enables that the user may record or download all kinds of audio files through various common household devices/tools, such as mobile phone and computer, and the audio sources are very extensive and diversified.

According to the present invention, multiple robot working states are provided, so that the robot not only plays different sounds in cases of state change, but also plays and uses the preset sounds in a stable state. For example, a reminder sound can be sent when the robot starts to work or the work is completed, and in the process of work, some kind of sound can also be sent, such as some light music, news and study material.

The robot in the present invention can be embodied as different types of robots with various functions. It can be embodied as small scale domestic robots such as washing machine, electric cooker and dust collector; it can also be embodied as some industrial robots. The speech system in the present invention does not involve significant additional cost, while it improves appetency of robot-person interaction, and thus increases the added value of these robots.

Finally it must be mentioned: Said embodiments are merely used to describe rather than limit the present invention. Although the detailed description of the present invention is provided with reference to preferred embodiments, those skilled in the art should understand that various modifications or equitable substitutions may be made to the present invention without deviation from the spirit and range of present invention.

1. A speech system used for robot, including an audio file storage unit (200, 200′) and a speech control unit (300, 300′, 300a, 300a′), wherein the audio file storage unit (200, 200′) stores the audio files obtained from an audio file preparation unit (100), characterized in the following:
the audio file preparation unit (100) is configured outside of the robot; the data stored in the audio file storage unit (200, 200′) can be prepared, modified or replaced according to the needs of a user; the speech control unit (300, 300′, 300a, 300a′) is coupled to the audio file storage unit (200, 200′) to realize information transmission and data reading; according to the received robot state information, the speech control unit (300, 300′, 300a, 300a′) converts the audio data of the audio file, which corresponds to the state information and is stored in the audio file storage unit (200, 200′), to a corresponding analog signal, and then plays the analog signal.

2. The speech system used for robot of claim 1, characterized in the following: the audio file storage unit (200) is an independent external storage unit to the robot, and it is communicated with the robot in wired or wireless mode, and may obtain the audio file from the audio file preparation unit (100) or from a third party in which the audio file prepared by the audio file preparation unit (100) is stored.

3. The speech system used for robot of claim 2, characterized in the following: the speech control unit (300) includes a control subunit (301), an audio signal processor (302) and a speaker (303), wherein the control subunit (301) is respectively connected with the audio signal processor (302) and the audio file storage unit (200);
wherein, according to the received robot state information, the control subunit (301) reads the audio file from the audio file storage unit (200) corresponding to the state information, and sends the audio file to the audio signal processor (302);
the audio signal processor (302) is used to make signal processing for the audio file, and outputs the processed analog signal which corresponds to the state information to the speaker (303) to be played.

4. The speech system used for robot of claim 2, characterized in the following: the speech control unit (300′) includes a control subunit (301′), an audio signal processor (302′) and a speaker (303′); the audio signal processor (302′) is respectively connected with the control subunit (301) and the audio file storage unit (200);
wherein, according to the received robot state information, the control subunit (301′) sends an information to the audio signal processor (302′) requesting the audio signal processor to output the audio data corresponding to the state information;
after receiving the information, the audio signal processor (302′) reads the audio file from the audio file storage unit (200) corresponding to the state information, makes signal processing for the audio file, and finally outputs the processed analog signal which corresponds to the state information, to the speaker (303′) to be played.

5. The speech system used for robot of claim 4, characterized in the following: the audio signal processor (302′), the speaker (303′) and the audio file storage unit (200) are integrated to constitute an external removable storage and playing device, which is independent to the robot.

6. The speech system used for robot of claim 5, characterized in the following: the control subunit (301′) is connected with the removable storage and playing device wirelessly.

7. The speech system used for robot of claim 3, characterized in the following: the audio file storage unit (200) may include a wireless communication circuit, and the control subunit (301) is coupled to the audio file storage unit (200) in wired or wireless connection.

8. The speech system used for robot of claim 4, characterized in the following: the audio file storage unit (200) may include a wireless communication circuit, and audio signal processor (302′) is coupled to the audio file storage unit (200) in wired or wireless connection.

9-11. (canceled)

12. The speech system used for robot of claim 1, characterized in the following: the audio file storage unit (200′) is a memory configured inside the robot; through a communication interface, the memory downloads or records the audio file from the audio file preparation unit (100) or from a third party in which the audio file prepared by the audio file preparation unit (100) is stored.

13. The speech system used for robot of claim 12, characterized in the following: the speech control unit (300a) includes a control subunit (301a), an audio signal processor (302a) and a speaker (303a), wherein the control subunit (301a) is respectively connected with the audio signal processor (302a) and the audio file storage unit (200′);
wherein, according to the received robot state information, the control subunit (301a) reads the audio file from the audio file storage unit (200′) corresponding to the state information, and sends the audio file to the audio signal processor (302a);
the audio signal processor (302a) processes the audio file signals and outputs the processed analog signal, which corresponds to the state information, to the speaker (303a) to be played.

14. The speech system used for robot of claim 12, characterized in the following: the speech control unit (300a′) includes a control subunit (301a), an audio signal processor (302a′) and a speaker (303a); the audio signal processor (302a′) is respectively connected with the control subunit (301a) and the audio file storage unit (200′);
wherein, according to the received robot state information, the control subunit (301a′) sends an information to the audio signal processor (302a′) requesting the audio signal processor to output the audio data corresponding to the state information; After receiving the information, the audio signal processor (302a′) reads the audio file from the audio file storage unit (200′) corresponding to the state information, makes signal processing for the audio file, and finally outputs the processed analog signal, which corresponds to the state information, to the speaker (303a′) to be played.

15. (canceled)

16. The speech system used for robot of claim 1, characterized in the following: a plurality of audio files corresponding to one state of the robot are stored in the audio file storage unit (200, 200′).

17. The speech system used for robot of claim 1, characterized in the following: the audio file is in the format of MP3, WAV, WMA, MP2, OGG, APE, AAC, MIDI or VQF.

18. The speech system used for robot of claim 1, characterized in the following: a built-in memory (400) is configured inside the robot to store the standard audio files corresponding to the robot states; according to the received robot state information and the application conditions, the speech control unit (300, 300′, 300a, 300a′) converts the audio data in the audio file, which corresponds to the state information and is stored in the audio file storage unit (200, 200′) or the built-in memory (400), to a corresponding analog signal to be played.

19. (canceled)

20. A robot with speech function, including a control system (500), a sensor system (600), a driver system (700), an implement mechanism (800) and a man-machine interface (900); wherein the man-machine interface (900) is used for man machine interaction, the control system (500) is used to control the driver system (700) so as to drive the implement mechanism (800) to perform corresponding tasks; the sensor system (600) is used to detect the operation states of the robot; characterized in the following:
the robot also includes the speech system as recited in claim 1; the speech system plays the audio files corresponding to the state information detected by the sensor system (600).

21. A robot with speech function of claim 20, characterized in the following: the speech control unit (300, 300, 300a, 300a′) in the speech system is a component unit of the control system (500).

22. A robot with the speech function of claim 20, characterized in the following: the robot is a dusting robot, wherein, the sensor system includes a sensor for detecting the working environment, a sensor for detecting the operation state and a signal processing circuit corresponding to the sensors; the implement mechanism is a cleaning unit; the driver system includes a working motor used to drive the cleaning unit to work, the wheels for mobility of the robot and a driving motor of the wheels; the control system is used to control the robot to complete the dusting work, and it interacts with the speech system to enable that different audio files are played under different operation states; the man-machine interface is the operation interface of the robot.

23. A robot with speech function of claim 22, characterized in the following: the sensors used to detect the operation state include an infrared sensor and/or a piezoelectric sensor.

24. The speech system used for robot of claim 2, characterized in the following: a built-in memory (400) is configured inside the robot to store the standard audio files corresponding to the robot states; according to the received robot state information and the application conditions, the speech control unit (300, 300′) converts the audio data in the audio file, which corresponds to the state information and is stored in the audio file storage unit (200) or the built-in memory (400), to a corresponding analog signal to be played.

25. The speech system used for robot of claim 12, characterized in the following: a built-in memory (400) is configured inside the robot to store the standard audio files corresponding to the robot states; according to the received robot state information and the application conditions, the speech control unit (300a, 300a′) converts the audio data in the audio file, which corresponds to the state information and is stored in the audio file storage unit (200′) or the built-in memory (400), to a corresponding analog signal to be played.
